(19) United States
(12) Patent Application Publication
(10) Pub. No.: US 2025/0040569 A1
(43) Pub. Date: Feb. 6, 2025

(54) SPONGY STARCH-FREE DAIRY SNACK AND METHOD FOR PRODUCING IT

(71) Applicant: SIGMA ALIMENTOS, S.A. DE C.V., Nuevo Leon (MX)

(72) Inventors: Alfonso PÉREZ GALLARDO, NUEVO LEON (MX); Bertha del Carmen MONTALVO HERNÁNDEZ, NUEVO LEON (MX); Emilio MÉNDEZ MERINO, LEON GUANAJUATO (MX)

(21) Appl. No.: 18/720,057

(22) PCT Filed: Dec. 14, 2022
(86) PCT No.: PCT/MX2022/000002

§ 371 Date: Jun. 14, 2024

(30) Foreign Application Priority Data
Dec. 16, 2021 (MX) MX/A/2021/015829

(51) Int. Cl. A23J 3/10; A23C 23/00; A23J 3/26

(52) U.S. Cl. CPC A23J 3/10; A23C 23/00; A23J 3/265

(57) ABSTRACT

A method for producing a spongy starch-free dairy snack, which comprises the steps of: preparing a food paste that includes 75-87% by weight OF acid casein and 13-25% by weight of powdered cheese; extruding the food paste at a pressure and temperature that enables the powdered cheese particles to fuse with the acid casein particles; cutting the string of extruded paste; allowing the pieces of extruded paste to expand; and drying the pieces of expanded paste until they contain 6-13% by weight of moisture, to obtain the spongy snack. The method also includes a step of hydrating the food paste with alkaline water before or during the step of extrusion. The obtained snack has a density of 75-150 g/L and a dry protein content of 80-89% by weight.

### TECHNICAL FIELD OF THE INVENTION

This invention relates to the field of the manufacture of extruded snacks, and more particularly, to a method for making a dairy snack presenting a starch-free spongy structure.

### BACKGROUND OF THE INVENTION

There is a wide variety of snack-type food products on the market; a snack-type food product is defined as a small-sized food, i.e., a single portion that can be eaten in one or several bites and is generally intended to be eaten with the fingers. Most commercially available snack-type food products are dry, salty tasting and are essentially composed of carbohydrates, fats and added flavors and flavorings, and are presented in the form of flakes, chips, puffed or extruded products. These snacks are of very limited nutritional interest, which is why the consumption of this type of product is often criticized.

The current trend in the elaboration of snack-type food products is to increase their nutritional value, either by elaborating the snack from proteins or by incorporating proteins to a traditional paste mixture to elaborate a snack. The proteins used in these cases are generally dairy or vegetable proteins.

In the prior art is known, for example, international patent application publication WO2012/036910 describing an expanded snack product made by an extrusion process from a mixture of starch, micelle casein and milk protein isolate, further added with an expansion control agent such as calcium carbonate. The obtained snack product is crunchy and contains at least 5 grams of protein per 28.35 gram serving.

Starch is an excellent ingredient to cause the expansion of direct expansion extrusion products. Starch is the reserve carbohydrate of plants, including cereals and legumes. In the extrusion process, its expansion capacity has to do with its ability to form melt masses of low viscosity compared to proteins and its capacity for hydrolysis or dextrinization. Remember that starch is ultimately composed of d-glucose units, so that during the extrusion process starch granules can be modified into lower molecular weight products such as shorter and shorter glucose chains and even dextrinize. High starch formulations are then more soluble, disintegrable, and assimilable during oral and gastrointestinal consumption than those containing their high protein counterparts, thus providing a higher glycemic index. On the other hand, direct expansion extruded products prepared with high protein content are less soluble, generate a feeling of satiety during consumption and have a lower glycemic index, providing a more balanced and less calorically dense nutritional content.

Mexican patent MX-291657 describes a snack of toasted texture, non-glazed, of fermented cellular structure, not inflated. The snack is made from a paste consisting of a mixture of 5 to 60% by weight of cheese, flour and water, said paste is extruded in the form of a configured paste rope at a pressure and temperature that prevents starch gelatinization and expansion of the paste, the configured paste rope is cut into pieces that are then baked or fried.

This patent describes the manufacture of what is known as an indirect expansion extruded product, this means extrusion is a means to achieve a paste that is shaped through a die, but that after extrusion is going to be fried, and it is during this frying process that the snack expands and generates its crunchiness. For this reason, it is sought that the starch does not gelatinize in the preparation of the rope. This formulation cannot be used in extruders with screws that have a shear profile and whose barrel reaches temperatures as described later in the process of the present invention.

International patent application publication WO2016/049198 describes a nutritional food composition for producing, among other things, snack-type food products. The nutritional food composition consists of not more than 60% by weight of milk protein and at least 40% by weight of vegetable protein. The milk protein may be milk protein concentrate, milk protein isolate, whey protein concentrate, skim milk powder, skim milk, whole milk, whole milk powder, whey protein isolate, whey protein concentrate, sodium caseinate and calcium caseinate; while vegetable protein can be soy protein, pea protein, rice protein, potato protein, macroalgae protein, microalgae protein, canola protein, sunflower protein, oat protein, wheat protein, collagen protein, peanut protein and corn protein.

The great disadvantage of vegetable proteins is that they are commercially available in the form of ingredients such as flours, concentrates or isolates, which present a characteristic legume flavor that is difficult to eliminate or mask. Even more so when using flours, which even have anti-nutritional factors such as protease inhibitors, hemagglutinins. The undesired effect of leguminous flavor, increase of excessive hardness increases as their proportion in the formula increases. Additionally, vegetable proteins have different denaturation temperatures than milk proteins, which makes it difficult for them to react at the same time in the extrusion process.

U.S. Pat. No. 9,723,859, describes a spongy snack made from a mixture of 65 to 85% by weight of acid casein, 5 to 40% by weight of whey protein and additionally an alkali, such mixture is fed to an extruder to which 3 to 30% by weight of water is added, the mixture is passed through a die attached to the extruder to create a plurality of cut pieces which are allowed to expand at an ambient temperature and pressure, then the moisture is removed until the snack pieces reach a moisture content of 0.5 to 12% by weight. The resulting snack contains an amount of protein of at least 75% by weight and does not contain any protein source other than casein and whey protein. This process is based on the extrusion of the mixture made with the acid casein and alkali in the form of a dilute solution or alkaline salt powder, which acts inside the extruder once the water is injected. The function of the alkali is to neutralize the acid casein and convert it into sodium caseinate. This process also allows the casein to be solubilized and converted into a molten mass also by shearing and heat transfer. The main drawback hereby is that the residence time of the materials in any extruder is not long enough to dissolve, neutralize and finally reach the necessary processing temperatures to unfold the full functionality of the acid casein. The result of this is the presence of incompletely melted casein particles and the obtaining of masses unable to fully expand upon reaching the extruder nozzle, so that the resulting snack, although it contains a protein amount of at least 75% by weight and contains no other protein source than casein protein and whey protein, its surface is rough with low exfoliating type structures and glassy texture.

Excessive use of whey changes the ratio of serum proteins to caseins, moving away from the ideal ratio of milk, additionally serum proteins cause caking of the formula preventing it from expanding properly when leaving the extruder, they also cause an important change in the viscosity of the molten mass inside the extruder, they are prone to burn inside the extruder barrel, they participate in the development of cooked flavors by the exchange of sulfhydryls (with a characteristic cooked egg or cooked milk flavor), the lactose contained in concentrated whey and even the isolates participate in caramelization reactions and production of furans that generate unpleasant flavors.

In order to solve the problems described above in the preparation of certain snack-type food products when dairy proteins are incorporated, the present invention proposes the use of cheese powder to produce a dairy snack having a crisp, non-glazed texture, of substantially uniform spongy structure of thin-walled alveoli exhibiting melted layers of overlapping proteins, with a protein level exceeding 81% protein on a dry basis and a low percentage of fat of the order of 8 to 12% by weight, from an extrudable food paste mixture, without the need to employ flours or starches.

### SUMMARY OF THE INVENTION

In view of the above described and with the purpose of providing a solution to the limitations encountered, it is the object of the invention to offer a method for making a spongy starch-free dairy snack, starting from the preparation of a food paste which includes from 75 to 87% by weight of acid casein and from 13 to 25% by weight of cheese powder, the food paste is extruded to obtain a string of extruded paste, the extrusion being at a pressure and temperature which allows the fusion of the cheese powder particles with the acid casein particles, the string of extruded paste is cut into pieces of extruded pasta which are allowed to expand in an environment with ambient pressure and temperature to form pieces expanded paste, which are then dried to obtain the spongy snack.

There is also an object of the invention a method for making a spongy starch-free dairy snack, starting from the preparation of a food paste which includes from 75 to 87% by weight of acid casein and from 13 to 25% by weight of cheese powder, the food paste is extruded to obtain a string of extruded paste, the extrusion being at a pressure and temperature which allows the fusion of the cheese powder particles with the acid casein particles, the string of extruded paste is cut into pieces of extruded pasta which are allowed to expand in an environment with ambient pressure and temperature to form pieces expanded paste, which are then dried to obtain the spongy snack.

Finally, it is an object of the present invention to provide a spongy starch-free dairy snack that exhibits a spongy three-dimensional shape with thin-walled alveoli exhibiting fused exfoliated layers of overlapping proteins, a density of 75 to 150 g/L and a protein content of 80 to 89% by weight on a dry basis.

### BRIEF DESCRIPTION OF THE DRAWINGS

Other features of the present invention will be apparent from the following detailed description considered in connection with the attached drawings. It should be understood, however, that the drawings are drawn only as an illustration and not as a limiting definition of the invention, in which:

FIG. 1 illustrates a photograph of a first example embodiment of a spongy dairy snack made from powdered cheddar cheese in accordance with the invention.

FIG. 2 illustrates a scanning electron microscopy micrograph of the first example embodiment of the spongy dairy snack of FIG. 1 in accordance with the invention.

FIG. 3 illustrates a photograph of a second example embodiment of a spongy dairy snack made from provolone cheese powder in accordance with the invention.

FIG. 4 illustrates a scanning electron microscopy micrograph of the second example realization of the spongy dairy snack of FIG. 3 in accordance with the invention.

FIG. 5 illustrates a photograph of a third example embodiment of a spongy dairy snack made from mozzarella cheese powder in accordance with the invention.

FIG. 6 illustrates a scanning electron microscopy micrograph of the third example realization of the spongy dairy snack of FIG. 5 in accordance with the invention.

### DETAILED DESCRIPTION OF THE INVENTION

The characteristic details of this invention are described in the following paragraphs, which are intended to define the invention, but without limiting its scope.

The present invention provides a method and system for the continuous production of an extruded spongy starch-free dairy snack that exhibits characteristics of texture (hardness), modulable size, shape, distribution of alveoli in regular sizes and with thin internal walls that result in a product of a density between 75 to 150 g/L, It is therefore a crunchy snack, which provides satiety when consumed and contains a higher nutritional content, with a cheese content of more than 10% by weight compared to a traditional starch-based snack.

The spongy starch-free dairy snack of the present invention is prepared from a food paste composition containing the following ingredients:

### a) Acid Casein

Acid casein and/or caseinates are included in the food paste mixture in an amount sufficient to provide protein and contribute to the structure of the spongy dairy snack. The acid casein ingredient can be obtained commercially or prepared by conventional processes. Acid casein can be obtained by acidifying skim milk (with mineral, organic acids or lactic cultures), reducing the pH to approximately 4.5 to 4.9 (but depending on the number of dissolved ions), so that the casein is precipitated leaving only the serum proteins in the whey. As is known, acid casein can be solubilized by the addition of an alkali or alkaline salt to form caseinates, such as sodium caseinates, calcium caseinates, etc., which can also be used, depending on the characteristics required. Lactic casein and rennet casein (obtained by enzymatic precipitation with proteases or similar enzymes) can also be used. Lactic casein is also obtained by adding microbial cultures to the milk, converting the lactose into lactic acid and thus lowering the pH. Rennet casein is obtained by using rennet to precipitate casein, resulting in a protein fraction with high calcium content. An example of acid casein processing is described in the background section of U.S. patent U.S. Pat. No. 4,397,926.

Casein is an animal protein with a complete amino acid profile unlike some of its vegetable counterparts. The term casein encompasses the dominant class of proteins in milk, accounting for about 80% of the proteins, the remainder being serum proteins. The different types of caseins include the subgroups αs1-casein, αs2-casein, κ-casein and β-casein, all heterogeneous and with 2-8 genetic variants. What makes them so special in this process is that due to their amino acid sequence they possess a distribution of ionizable groups, hydrophilic domains, and hydrophobic domains. That is why they are so versatile to be modified in their structure and function by changes in the presence of calcium ions, phosphate groups and pH conditions.

All caseins in their native state do not have a well-defined tertiary or secondary structure (due to their proline content), however, they exhibit a remarkable biological function in this unstructured form. The main one is the ability to self-associate for the formation of so-called casein sub-micelles and micelles. Theα s1-casein, αs2-casein, and β-casein are typically found as calcium salts and are practically insoluble, whereas the k-casein is soluble: the association of the first three inside the micelle as the k-casein faces outward (along with its C-terminal end containing a carbohydrate group) is what confers to the sub-micelle its solubility. Sub-micelles can also associate and stabilize with other micelles through hydrophobic interactions and calcium phosphate, to form micelles ranging from 200-400 nm. In the present invention this micellar structure is the property of greatest interest because of its precipitation capacity at acid pH (4.6 to 4.9) which allows obtaining a dense coagulum that can subsequently be dried and, once dried, can be re-solubilized in the form of sodium caseinate.

The advantage that acid casein brings to the process of the present invention is that it does not immediately upon contact with water generate a paste of high viscosity. This is because its re-solubilization process is slow, which allows the mixture of aqueous alkali (hydroxide) with acid casein (and the rest of the formula) to be efficiently transported to the interior of the extruder and reach the still liquid compression zone preventing clogging and deposition of burnt protein which tends to stick to the surface of the interior of the barrel or die or die cutter outlet of the extruder.

The acid casein may be employed in an amount from about 75% by weight to about 87% by weight, preferably from about 78% by weight to about 87% by weight, more preferably from about 80% by weight to about 84% by weight, based on the weight of the food paste.

### b) Cheese Powder

The cheese used in the present invention may be any one or more of a real cheese or dairy cheese. Without distinction, it may be cow's, goat's or sheep's milk cheese, such as fresh cheese (white cheese, queso ackawi, fresh/white cheese, panela cheese, cotija cheese, heavy cream cheese, frying cheese, panner cheese), semi-mature cheese (chihuahua cheese, gouda cheese, camembert, roquefort, stilton, gruyere), mature cheese (manchego, cheddar, morbier, blue cheese, limburger cheese, asiago cheese, parmesan cheese, romano cheese, swiss cheese, muenster cheese, mozzarella cheese, Monterey Jack cheese, Pepper Jack cheese, provolone cheese, fontina cheese, pecorino cheese, grana pandano cheese, gorgonzola cheese), and the like and any combination of the foregoing although not limited to these. In embodiments of the invention, dairy cheese may have a moisture content of 3% to 6% by weight, with a fat content of 8% to 50% by weight, and a protein content of 20% to 65% by weight. Cheeses with higher moisture content may be difficult to pulverize, and/or may boil and/or generate very wet, molten masses that are not easy to dry and develop a hard, glazed botanical.

The cheese employed in the present invention is applied in powder form with a particle size of about 0.005-1500 micrometers, more preferably 0.010-1000 micrometers and most preferably 0.025-500 micrometers. Said cheese powder can be obtained, but is not limited to different processes such as roller dryers, drum dryers, vacuum drying, freeze drying or spray drying. Prior to drying there can be grinding or particle size reduction processes to optimize the process, in this step the cheese is ground to generate smaller particles that by increasing the surface area are dried more efficiently.

One process that has been found mentions that it is possible to start from cheese bars or chunks that are introduced to a shredder, pulverizer or blade rotor mill inside, in which a stream of cheese is subjected to the rotating mechanical action of said blade rotor, with the consequent division of the cheese into small particles. The shredder, pulverizer or grinder can be configured to reduce the average particle size of the cheese. However, any suitable structure and/or method may be employed to reduce the average particle size of the cheese. An example of a process for making cheese powder is described in European Patent EP2386207.

The cheese powder may be employed in an amount from about 10% by weight to about 25% by weight, preferably from about 13% by weight to about 20% by weight, more preferably from about 14% by weight to about 17% by weight, based on the weight of the food paste. The cheese powder helps to provide lubrication during preparation of the food paste, mixing of the food paste, and extrusion of the food paste. Excessive amounts of cheese powder can soften the food paste too much and can detract from the shape retention of the food paste during its expansion as it exits the extruder, but this clearly depends on the level of proteolysis of the cheese, its formulation, its production process, cultivation and/or maturation, as well as the fat-to-protein ratio with which it was made. Also, excessive amounts of cheese powder, depending on its fat-protein ratio and degree of proteolysis, can detract from the achievement of a crunchy texture of the snack obtained in accordance with the above, because a viscoelastic, melted, sticky mass with high water retention capacity is generated.

When in the extrusion process of the sponge milk snack of the present invention working with masses exhibiting the above mentioned characteristics, two effects are caused: (1) the expanded particles stick to each other and become caked, they also stick to the surfaces of the processing equipment as they exit the extruder and; (2) the expanded particles are not able to retain their expanded shape. This second point occurs because at the exit of the extruder, due to the difference in pressures and temperature inside the barrel vs. the atmospheric pressure outside, the water contained in the molten mixture suddenly expands (flashes). During this expansion the water changes phase from liquid to vapor and escapes from the molten mixture. Due to the decrease in humidity, hardening of the expanded particle is achieved, which helps it to retain its shape. This process is almost instantaneous and depends as mentioned on the amount of water in the matter balance of the formulation, but also on the strength with which the molten mixture is able to bind water.

If the conditions of moisture and degree of retention in the molten mixture are correct, as is the case in the examples of the present invention, the product expands suddenly releasing between 3% and 10% moisture, more preferably between 4% and 8% moisture and more preferably between 5% and 6% moisture, in a rapid manner. This causes hardening of the particle, but the degree of expansion with respect to the diameter of the die is such that a honeycomb structure and thin walls are achieved in the expanded particle, which are what give it a suitable crunchiness and palatability.

In preferred embodiments, high levels of cheese powder content contribute their characteristic flavor and help to increase the protein content of the formulation, as well as act in the heat transfer of the final snack product and because they contribute fat embedded particles to the formation of a homogeneous melt within the extruder. For example, for products where a strong cheese flavor is desired, higher cheese contents and intense flavors such as ripened cheeses (e.g., Romano, Parmesan, Pecorino, Grana Padano, but not limited to those) are preferred. For this purpose, approximately 15% by weight to approximately 25% by weight, based on the weight of the food paste, may be added, but not limited to.

There are many commercial brands of cheese powders on the market which can be employed in the practice of the present invention. These can be employed alone or as blends, or in combination with cheese flavors (which are cheese powders with other ingredients). The cheese powders are simply dehydrated cheese, usually dried by some method by which it is possible to remove moisture from it until it is technically dry to appropriate levels with a moisture range between 0 and 10% preferably between 1% to 8% and more preferably between 2% to 4% moisture.

The fat content of the dry cheese ranges between 10 and 60%, preferably between 20% and 50%, and more preferably between 30 to 45%. Additionally, the cheeses are available in several different flavors, for example, Swiss, cheddar, aged or unaged, and perhaps colored or uncolored. Preferably, powdered cheeses are marketed with a moisture content between 0 and 10% preferably between 1% to 8% and more preferably between 2% to 4% moisture.

### c) Oils and Fats

Edible fats and oils represent the most important source of energy in food, providing 9 cal/g, twice as much as proteins (4 cal/g) or carbohydrates (4 cal/g). They are a vehicle for fat-soluble vitamins and contribute significantly to the flavor and aroma of cooked foods. They also provide a feeling of satiety. Among their functional properties is the regulation of heat exchange, they provide flavor, texture and body to foods, and at the same time they are a vehicle for hydrophobic compounds. From a molecular point of view, fats (including oils and solid fats) are made up of triacylglycerides (TAGs), which means that they are made up of a glycerol molecule to which three fatty acids are attached. What distinguishes an oil from a fat is that the former are liquids at room temperature, while the latter are solids at room temperature in technical terms and industrial application, the parameters that define these behaviors are their respective crystallization and melting points. This thermal behavior is of course based on the fatty acid (FA) profile and the positions these FAs occupy in the glycerol molecule. The FA profile also refers to the type of fatty acid in terms of chain length and abundance, thus defining functionality properties such as melting/crystallization range, solids fraction at a given temperature, rheological behavior, plasticity, palatability, and sensory perception. FAs can be saturated fatty acids (SFA), mono-unsaturated fatty acids (MUFA), polyunsaturated fatty acids (PUFA) and trans fatty acids (TFA). Depending on the chain length and degree of unsaturation. Finally, there are other acylglycerides such as diacylglycerols (DAG), monoacylglycerols (MAG), phospholipids and other related molecules of lipid origin.

TAG, DAG and MAG are of importance in the composition of the food paste of the present invention because they provide lubrication to the screw and barrel system which allows the melt to flow without sticking to the extruder components, additionally they provide an efficient means for heat transfer, contribute as a material that improves the sensory perception and palatability and aroma during the consumption of the snack. DAG and MAG also provide emulsifying properties to the formulations containing them and function as adjuvants in the fluidization of the mixture.

Another crucial point is that TAGs may be added containing essential fatty acids (those that cannot be synthesized by the body and that must be acquired through food consumption) such as omega-3 and omega-6 PUFAs called α-linolenic acid and α-linoleic acid, respectively.

In the present invention, butterfat can preferably be used, i.e., fat extracted from bovine, ovine or caprine milk characterized by its content of short-chain FA's such as butyric FA. This is in order to maintain the identity of a dairy product made entirely from dairy products. However, vegetable oils can also be employed in an alternative way to make the food paste of the invention.

The vegetable oils also exhibit compatibility with the acid casein and cheese powder to be miscible at the temperature ranges of this invention with the butterfat constituent contained in the cheese powder, in any proportion, and especially to provide a crisp and fluffy texture to the cheese snack.

Vegetable oils/fats likely to be employed include, but are not limited to, for example, canola oil, sunflower oil, safflower oil, olive oil, corn oil, soybean oil, coconut oil, butterfat, and combinations thereof. Vegetable or animal oil may be employed in an amount of up to about 12% by weight, preferably from about 1% by weight to about 8% by weight, more preferably from about 2% by weight to about 6% by weight, based on the weight of the food paste.

Likewise, fats of vegetable or animal origin can be used, among the fats of vegetable origin that can be used are palm fat and its fractions and coconut fat, and their combinations; among the fats of animal origin that can be used are milk fat, butterfat or its fractions, animal tallow, and their combinations.

### d) Other Ingredients

Other ingredients that may be used in the preparation of the snack but are not essential are flavorings of vegetable extracts of leaves, stems, twigs, herbs or seeds or dried vegetables or colorings such as annatto, paprika or some other commonly used to flavor and color cheeses or foods prepared with these. Examples of these materials are rosemary, basil, mushrooms such as blue or green mushrooms, pepper, sesame, dried tomato, dried bell pepper, smoke flavoring agents. These ingredients are not necessary to produce the formulation described in the present invention, but may contribute additional color, appearance, and flavors.

### Method of Preparation

A food paste is prepared by mixing the acid casein with the cheese powder, and additionally with the vegetable oil. These ingredients can be mixed and/or combined using any suitable method and/or system, including, but not limited to mixing tanks, mixers, conveyors, and/or combinations thereof. The food paste can be prepared using conventional mixing equipment, such as an up-mixer or batch mixer. The ingredients can be added individually, separately, and in liquid or dry forms, without limitation. In various embodiments of the invention, the food paste may be produced by continuously adding the ingredients to the mixer to obtain a substantially homogeneous food paste to be extruded, whereby the mixer may operate from about 15 rpm to about 300 rpm for about 1 minute to about 20 minutes, but preferably 5-15 minutes and more preferably 10 min. The types of mixers may be, but are not limited to rotating drum type, ribbon type, co-rotating paddle type or counter-rotating paddle type.

The moisture content of these ingredients may be from about 2% to about 15% by weight, however, alternatively said moisture content of the ingredients may be conditioned by the addition of water, preferably alkaline water, by use of a pre-conditioner prior to mixing or during mixing of the ingredients. The added water content is from about 2% to about 15% by weight, based on the weight of the food paste. The preferable moisture content for the process is between 5% to 10% more preferably between 6% to 9%.

In one embodiment of the invention, it is contemplated that the density of the powder mixture ranges in a range from about 300 to about 800 g/L, preferably between 400 to 700 g/L and more preferably from 500 to 600 g/L.

The food paste is introduced into an extruder, the extruder can be configured as a single-screw or twin-screw, co-rotating or counter-rotating extruder, with a feed zone, one or more heating zones where melt mixing occurs, but the extruder can be configured differently in other modes.

During extrusion of the food paste, water, preferably alkaline water, can be added to the extruder in the amount of from about 2% to about 15% by weight, based on the weight of the food paste. The preferable alkaline water content for the process is between 5% to 10% and more preferably between 6% to 9%.

The food paste can be fed or pumped to the extruder, using a displacement pump or screws. The mass flow (kg/h) depends on the size and capacity of the equipment. However, for the present invention the process of an extruder with a maximum capacity of 50 kg/h at 600 rpm is mentioned.

The extrusion can be conducted at a pressure of about 40 to 100 bar, more preferably from 50 to 90 bar and most preferably from 60 to 80 bar. High extrusion pressures tend to change the structure of the alveoli of the string of extruded paste and generate greater expansion at the outlet. Generally, the higher the pressure, the lower the degree of expansion of the extruded paste at the extruder outlet and therefore the more alveolar the texture of the snack will be. In contrast, low extrusion pressures tend to reduce the expansion and obtain more discrete structures, as well as reduce the sudden loss of water by evaporation, thus obtaining a harder snack.

During extrusion, the temperature of the food paste increases as the residence time within the extruder increases. In one embodiment of the invention, the residence time of the food paste within the extruder may be from about 5 seconds to about 30 seconds residence time. Accordingly, the temperature range in or around the extruder feed zone may be from about 20° C. to about 40° C. more preferably from about 25 to 35° C., the temperature range in or around the extruder plasticizing zone may be from about 40° C. to 110° C., preferably from 50° C. to 90° C. and more preferably from 60 to 80° C., the temperature range in or around the extruder expansion and shear zone may be from about 80° C. to about 110° C. However, heat exchangers can be employed to add or remove heat from the extruder (or food paste) in any zone of the extruder since the neutralization reaction of the acid casein is exothermic (releases heat) and this adds heat to the molten mixture so that heat must be removed in the plasticizing zone.

High extrusion temperatures result in thermal degradation, caramelization (of lactose) and carbonization of milk proteins (serum and caseins) resulting in sticking of the melt to the interior. In addition, a substantial part of the acidic casein results in a snack with a hard, burnt-flavored, caramel or brown texture instead of a crisp, fluffy, non-glazed, white texture. Also, high temperatures, e.g., above the boiling point of water tend to cause excessive swelling or expansion of the extruded paste as it exits the extrusion die/die.

When the extruded food paste exits the extruder, the extruded food paste may expand so that its density inside the extruder is greater than its density after exiting the extruder. In addition, a portion of the water content in the extruded food paste may evaporate due to the pressure differential between the inner portion of the extruder and the outside of the extruder. The food paste is forced out of the extrusion die, forming a configured extruded paste rope which is subsequently cut, or as the extruded food paste exits the extruder, it is cut into configured extruded paste pieces, which can be done via a cutter coupled with the extruder. The configured strings of extruded paste or configured pieces of extruded paste may be tempered and/or dried to achieve a desired final moisture content in the spongy starch-free dairy snack product, which may be from about 6% to about 13% by weight, preferably 7% to 11% and more preferably between 8% to 10% by weight. The protein content in the spongy starch-free dairy snack may be from about 81% to about 89% by weight on a dry weight basis.

In one embodiment, the configured extruded paste can be tempered and/or dried using a fluidized bed dryer or oven or can be exposed to hot air for drying purposes as the product exits the extruder. In addition, the configured extruded paste product may be conveyed from the extruder through a belt conveyor system configured to remove a portion of the moisture from the product during transport. In another embodiment, the conveying system can deliver the configured extruded paste product to a dryer, which can be any dryer suitable for removing moisture from the spongy starch-free dairy snack, including, but not limited to microwave ovens, convection ovens, fluidized bed dryers, drum dryers, forced air dryers, and/or combinations thereof.

The spongy starch-free dairy snack product has the advantage of being able to be consumed directly without further processing and, in particular, without seasoning. However, in one embodiment the spongy starch-free dairy snack pieces can be coated with conventional seasonings once they have been dried, using conventional seasoning application equipment, such as a rotating drum.

Spongy starch-free dairy snack pieces can be conveyed from a dryer to a sieve and product pieces within certain criteria (e.g., length, width, volume, etc.) can be diverted to a primary stream. The spongy starch-free dairy snack can be exposed to a magnetic field to remove any magnetic material and/or passed through a metal detector. The spongy starch-free dairy snack may be placed in a holding tank for packaging and/or further processing, or may be packaged directly for shipping or sale. It is contemplated that the spongy starch-free dairy snack may be packaged in bags and/or boxes or totes.

### EXAMPLES OF EMBODIMENTS OF THE INVENTION

The invention will now be described with respect to the following examples, which are solely for the purpose of depicting the manner of carrying out the implementation of the principles of the invention. The following examples are not intended to be an exhaustive representation of the invention, nor are they intended to limit the scope thereof.

### Example 1: Powdered Cheddar Cheese-Based Spongy Dairy Snack

### a) Mode of Preparation:

The powders were put into a PULVEX ribbon blender with two turns to ensure powder homogeneity. The mixing time is 10 minutes. To produce an extruded snack with cheddar cheese powder, 33.2 kg of Fonterra brand acid casein and 6.80 kg of Lactosan brand cheddar cheese powder are put into the mixer. The mix ratio is 83% sour casein and 17% cheddar cheese powder. The cheddar cheese powder is composed of cheddar cheese and disodium phosphate salts (maximum 5%).

The extruder used is a Clextral EVOLUM 32 co-rotating extruder equipped with a pre-conditioner. The extrusion parameters show in Table 1.

In this formulation, fat is added by injection into the extruder barrel. For this purpose, anhydrous butterfat (AMF) was used with a flow rate of 1.7 l/h at a mass ratio in the extruder of 3.7%.

TABLE 1

| Parameter | Temperature | Unit |
|---|---|---|
| Zone 1 Temperature | 30 | ° C. |
| Zone 2 Temperature | 39 | ° C. |
| Zone 3 Temperature | 47 | ° C. |
| Zone 4 Temperature | 48 | ° C. |
| Zone 5 Temperature | 56 | ° C. |
| Zone 6 Temperature | 67 | ° C. |
| Zone 7 Temperature | 71 | ° C. |
| Zone 8 Temperature | 72 | ° C. |
| Zone 9 Temperature | 51 | ° C. |
| Powder feed rate | 40 | Kg h⁻¹ |
| Pre-conditioner speed | 194.2 | RPM |
| Volumetric flow rate of alkaline | 4.4 | L h⁻¹ |
| water @ 0.8% w/w NaOH | | |
| Butterfat flow | 1.7 | L h⁻¹ |
| Extruder screw feed rate | 600 | RPM |
| Screw torque | 45 | % |
| Pressure | 75-80 | bar |
| Extruded outlet temperature | 98-99 | 0 |
| EMS (mechanical energy) | 130-140 | W h kg⁻¹ |
| Cutter speed (speed) | 900-1000 | RPM |

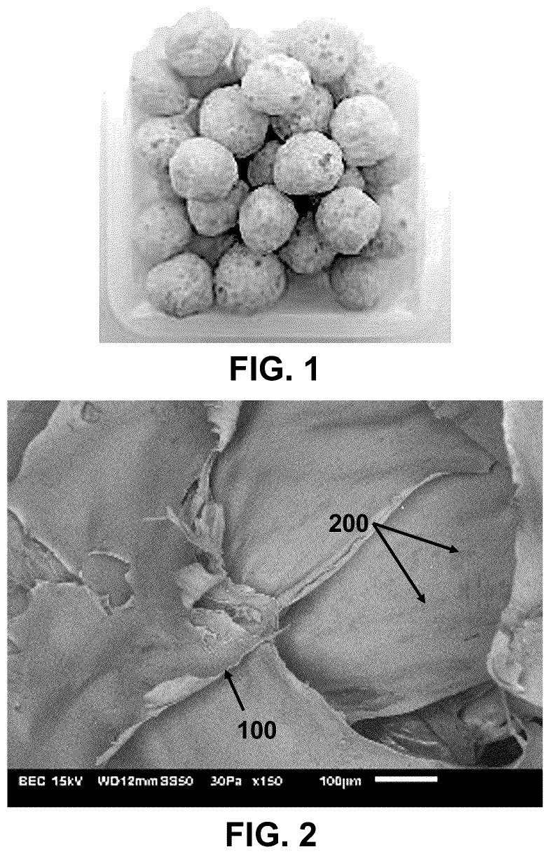

The extruder has a round die with a 5 mm insert, to which an automatic cutter with variable speed controllable by means of the extruder control panel is fitted flush. The extruded product is received in grid-type containers to ensure a constant air flow and that the product loses temperature with the environment. At the same time, to prevent the product from keeping humidity and the formation of clumps, the product is continuously stirred manually. To dry the extrudate, the product is placed in perforated trays previously released and placed in a Flowcook air dryer. The drying conditions are as follows: temperature 100° C. with a residence time of 10 minutes and fans at 350 rpm/min. The spongy starch-free dairy snack obtained is shown in FIG. 1 in spherical shape.

### b) Organoleptic Parameters and Microstructure.

The texture, density and dimensional properties of the extruded particles obtained in Example 1 are shown in Table 2.

TABLE 2

| Parameter | Standard | Range | Unit |
|---|---|---|---|
| Product density | 95 | ±5 | g/L |
| Part weight | 0.48 | ±0.02 | g |
| Long | 1.6 | ±0.1 | cm |
| Width | 1.3 | ±0.1 | cm |
| Hardness | 1.00 | ±0.4 | Kg/cm² |

In terms of sensory perception in terms of taste and smell, the product has a crunchy texture comparable to a starchy snack, but with the advantage that it has a protein content of about 83.5% protein on a dry basis. The product also contains flavor and aroma notes typical of cheddar cheese and milk.

The spongy starch-free dairy snack obtained in the present example presents a microstructure that is shown in FIG. 2, in which a morphology of layers 100 that slide between them following an exfoliation pattern can be appreciated. The exfoliated layers 100 are less than 2 μm thick as can be seen in said figure when compared against the scale bar of the scanning electron microscopy micrograph. This characteristic of 100 exfoliated layers, allows to have a crunchy snack, which hydrates quickly in the consumer's mouth, contributing with its palatability and pleasant swallowing. Cheese, due to its fat content, is detectable in these exfoliated layers in the areas 200 that are visibly darker in color than the rest of the surface.

### c) Nutritional Value

Table 3 shows the nutritional content of the product based on 100 g obtained by bromatological analysis.

TABLE 3

| | | |
|---|---|---|
| Nutrient declaration (Wet basis) | 100 | g |
| Energy content | 410 | kcal |
| Proteins (wet basis) | 80 | g |
| Protein (dry basis) | 83.5 | g |
| Total fat | 10 | g |
| Saturated fats | 6 | g |
| Available carbohydrates | 2 | g |
| Added sugars | 0 | g |
| Dietary fiber | 0 | g |
| Sodium | 475 | mg |
| Calcium | 130 | mg |

### Example 2: Powdered Provolone Cheese-Based Spongy Dairy Snack

### a) Mode of Preparation:

The powders were incorporated in a PULVEX ribbon blender and mixed for 10 minutes to ensure powder homogeneity. The total mixing time is 10 minutes. For the production of an extruded snack with cheddar cheese powder, 34 kg of Fonterra brand acid casein and 6 kg of Lactosan brand provolone cheese powder are incorporated into the mixer. The mix ratio is 85% acid casein and 15% provolone cheese powder. The provolone cheese powder is composed of provolone cheese and disodium phosphate salts (maximum 5%).

The extruder used is a Clextral Evolum 32 co-rotating extruder equipped with a pre-conditioner. The extrusion parameters are shown in Table 4.

TABLE 4

| Parameter | Temperature | Unit |
|---|---|---|
| Zone 1 Temperature | 31 | ° C. |
| Zone 2 Temperature | 35 | ° C. |
| Zone 3 Temperature | 45 | ° C. |
| Zone 4 Temperature | 44 | ° C. |
| Zone 5 Temperature | 59 | ° C. |
| Zone 6 Temperature | 71 | ° C. |
| Zone 7 Temperature | 69 | ° C. |
| Zone 8 Temperature | 71 | ° C. |
| Zone 9 Temperature | 52 | ° C. |
| Powder feed rate | 40 | Kg h⁻¹ |
| Pre-conditioner speed | 194.2 | RPM |
| Volumetric flow rate of alkaline | 4.4 | L h⁻¹ |
| water @ 0.8% w/w NaOH | | |
| Butterfat flow | 1.7 | L h⁻¹ |
| Extruder screw feed rate | 600 | RPM |
| Screw torque | 40 | % |
| Pressure | 72 | bar |
| Extruded outlet temperature | 103 | ° C. |
| EMS (mechanical energy) | 120 | W h kg⁻¹ |
| Cutter speed (speed) | 1000 | RPM |

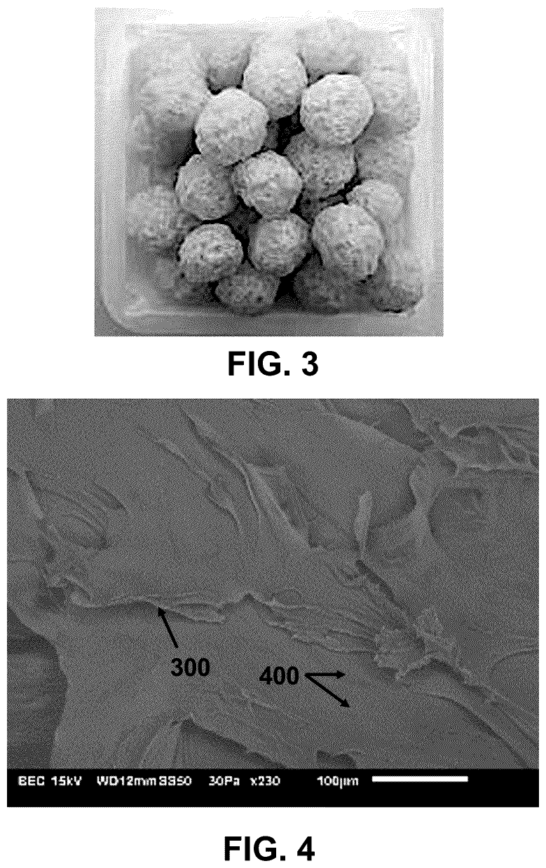

The extruder has a round die with a 5 mm insert, to which an automatic cutter with variable speed drive, controllable through the extruder control panel, is fitted flush with the extruder. The extruded product is received in grid-type containers to ensure a constant air flow and that the product loses temperature with the environment. At the same time, to prevent the product from keeping humidity and the formation of clumps, the product is continuously stirred manually. To dry the extrudate, the product is placed in perforated trays previously released and placed in a Flowcook air dryer. The drying conditions are as follows: temperature 100° C. with a residence time of 10 minutes and fans at 350 rpm/min. The spongy starch-free dairy snack obtained is shown in FIG. 3 in spherical shape.

### b) Organoleptic Parameters and Microstructure

The texture, density and dimensional properties of the extruded particles obtained in Example 2 are shown in Table 5.

TABLE 5

| Parameter | Standard | Range | Unit |
|---|---|---|---|
| Product density | 111 | ±5 | g/L |
| Part weight | 0.5 | ±0.1 | g |
| Long | 1.5 | ±0.1 | cm |
| Width | 1.25 | ±0.1 | cm |
| Hardness | 1.02 | ±0.4 | Kg/cm² |

The product has a crunchy texture comparable to a starchy snack, but with the advantage that it has a protein content higher than 83.6 on a dry basis. The provolone cheese profile is maintained in the product giving mature cheese flavors.

The spongy starch-free dairy snack obtained in the present example presents a microstructure that is shown in FIG. 4, in which a morphology of layers 300 that slide between them following an exfoliation pattern can be appreciated. The exfoliated layers 300 are less than 2 μm thick as can be seen in said figure when compared against the scale bar of the scanning electron microscopy micrograph. This characteristic of 300 exfoliated layers, allows to have a crunchy snack, which hydrates quickly in the consumer's mouth, contributing with its palatability and pleasant swallowing. Cheese, due to its fat content, is detectable in these exfoliated layers 300 in the areas 400 that are visibly darker in color than the rest of the surface. FIG. 4 shows that the exfoliated layers 300, due to the expansion process at the extruder die exit, are thinner than those obtained when cheddar cheese is used (see FIG. 2), because provolone cheese is produced by means of a pasta filata or filata (strand forming) process and has a cooking step in its production process, while cheddar cheese is not subjected to these two processes.

### c) Nutritional Value

Table 6 shows the nutritional content of the product based on 100 g obtained by bromatological analysis.

TABLE 6

| | | |
|---|---|---|
| Nutrition declaration | 100 | g |
| Energy content | 403 | kcal |
| Proteins (wet basis) | 78 | g |
| Protein (dry basis) | 83.6 | g |
| Total fat | 9 | g |
| Saturated fats | 5.76 | g |
| Available carbohydrates | 2.5 | g |
| Added sugars | 0 | g |
| Dietary fiber | 0 | g |
| Sodium | 550 | mg |
| Calcium | 200 | mg |

### Example 3: Powdered Mozzarella Cheese-Based Spongy Dairy Snack

### a) Mode of Preparation:

The powders were incorporated into a PULVEX ribbon blender to ensure homogeneity of the powdered ingredient mixture. For this product, canola vegetable oil was added to the powders to reduce friction in the extruder equipment and allow the mixture to flow once it was melted inside. During the aforementioned 10-minute mixing time of the powders, the vegetable oil is incorporated little by little by means of an atomizing nozzle to the mixture, giving an additional mixing time of 12 minutes, which gives a total mixing time of 22 minutes. For the production of the extruded snack, 52.2 kg of Fonterra brand acid casein, 6 kg of Lactosan brand mozzarella cheese powder and 1.8 kg of canola oil are incorporated into the mixer. The mix ratio is 87% acid casein, 10% mozzarella cheese powder and 3% canola vegetable oil. The mozzarella cheese powder contains mozzarella cheese and disodium phosphate salts (maximum 5%).

The extruder used is a Clextral model Evolum 32 co-rotating extruder equipped with a pre-conditioner. The extrusion parameters are shown in Table 7.

TABLE 7

| Parameter | Temperature | Unit |
|---|---|---|
| Zone 1 Temperature | 29 | ° C. |
| Zone 2 Temperature | 34 | ° C. |
| Zone 3 Temperature | 51 | ° C. |
| Zone 4 Temperature | 49 | ° C. |
| Zone 5 Temperature | 68 | ° C. |
| Zone 6 Temperature | 74 | ° C. |
| Zone 7 Temperature | 73 | ° C. |
| Zone 8 Temperature | 72 | ° C. |
| Zone 9 Temperature | 53 | ° C. |
| Powder feed rate | 40 | Kg h⁻¹ |
| Pre-conditioner speed | 194.2 | RPM |
| Alkaline water volumetric flow | 4 | L h⁻¹ |
| rate @ 0.8% w/w NaOH | | |
| Butterfat flow | 1.8 | L h⁻¹ |
| Feed rate of extruder screws | 575 | RPM |
| Screw torque | 44 | % |
| Pressure | 75-80 | bar |
| Extruded outlet temperature | 96-98 | ° C. |
| EMS (mechanical energy) | 130-140 | W h kg⁻¹ |
| Cutter speed (speed) | 1000 | RPM |

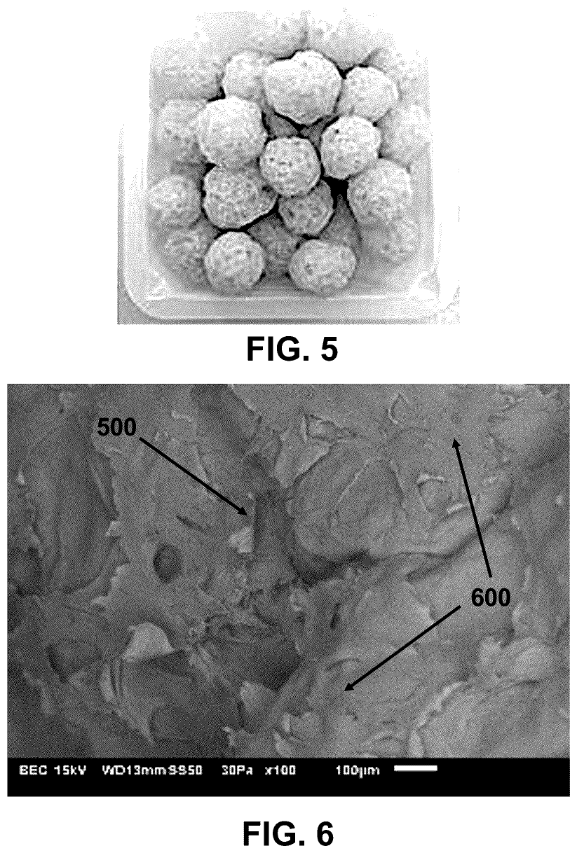

The extruder has a round die with a 5 mm insert, to which an automatic cutter with variable speed drive, controllable through the extruder control panel, is fitted flush with the extruder. The extruded product is received in grid-type containers to ensure a constant air flow and that the product loses temperature with the environment. At the same time, to prevent the product from keeping humidity and the formation of clumps, the product is continuously stirred manually. To dry the extrudate, the product is placed in perforated trays previously released and placed in a Flowcook air dryer. The drying conditions are as follows: temperature 100° C. with a residence time of 10 minutes and fans at 350 rpm/min. The spongy starch-free dairy snack obtained is shown in FIG. 5 in spherical shape.

### b) Organoleptic Parameters and Microstructure

The texture, density and dimensional properties of the extruded particles obtained in Example 3 are shown in Table 8.

TABLE 8

| Parameter | Standard | Range | Unit |
|---|---|---|---|
| Product density | 80 | ±3 | g/L |
| Part weight | 3.6 | ±0.1 | g |
| Long | 1.77 | + 0.1 | cm |
| Width | 1.45 | ±0.1 | cm |
| Hardness | 0.7 | ±0.15 | Kg/cm² |

The product has a crisp texture and a mozzarella cheese aroma profile and is perceived as slightly more airy and delicate in its crispness than its counterparts prepared with provolone or cheddar, as evidenced by its hardness values in compression (Table 8). Milky notes typical of Mozzarella cheese can also be observed.

The spongy starch-free dairy snack obtained in the present example presents a microstructure that is shown in FIG. 6, in which a morphology of layers 500 that slide between them following an exfoliation pattern similar to the one obtained in the previous examples can be appreciated (See FIGS. 2 and 4). However, it can be observed that the exfoliated layers 500, similar to flakes, are smaller in size, which indicates that in this formulation the mozzarella cheese provides elasticity properties in the melt, but due to its high resilience capacity, on the surface of the spongy starch-free dairy snack, the melt is segmented in greater proportion. This is because when the snack comes out of the extruder it is molten and elastic and expands as mentioned above, but the moisture evaporates suddenly due to pressure and temperature differences, so the mass containing mozzarella hardens quickly and becomes segmented causing an interruption of the strand, which results in the formation of this surface pattern. The cheese, because of its fat content, is detectable in these 500 exfoliated layers in areas 600 which are visibly darker in color than the rest of the surface.

As can be seen in the above examples, each type of cheese contributes different properties to the spongy starch-free dairy snack in terms of surface properties, and this is due to its degree of proteolysis, the process by which it was produced, whether or not it contains fluxing salts, whether or not it was malaxed, the type of culture, pH, whether or not it was previously cooked, although not limited to these processing steps. To exemplify this, mozzarella cheese has the effect of generating a microstructure of smaller exfoliated layers (flakes) than its counterparts prepared with cheddar and provolone. It should be noted that mozzarella cheese receives a similar process to provolone but receives a malaxation process (melting and aligning of proteins by mechanical work to achieve a firm but elastic cheese mass). With mozzarella cheese again the thickness of the exfoliated layers is less than 2 μm thick when compared against the scale bar of the scanning electron microscopy micrograph. This characteristic of 500 exfoliated layers allows to have a crunchy snack, which hydrates quickly in the consumer's mouth, contributing to its palatability and pleasant swallowing.

### c) Nutritional Value

Table 9 shows the nutritional content of the product based on 100 g obtained by bromatological analysis.

TABLE 9

| | | |
|---|---|---|
| Nutrition declaration | 100 | g |
| Energy content | 394.5 | kcal |
| Proteins (wet basis) | 77 | g |
| Protein (dry basis) | 83.8 | g |
| Total fat | 8.5 | g |
| Saturated fats | 2.7 | g |
| Available carbohydrates | 2.5 | g |
| Added sugars | 0 | g |
| Dietary fiber | 0 | g |
| Sodium | 475 | mg |
| Calcium | 180 | mg |

With the process described here it is possible to obtain a snack with high protein content and crunchy texture. The use of powdered cheese in the formulation allows for clean dairy sensory profiles, obtaining white expanded particles and removing the challenge presented using vegetable proteins which give undesirable flavor profiles such as the typical legume or cooked bean flavor. The protein quality of the product contains a good balance of amino acids, in addition to containing a lower fat concentration compared to regular snacks. The milk and cheese protein expansion process is unique for its honeycomb structure and moderate crunchiness.

Additionally in the examples we can notice that the process temperatures for these milk protein formulations are lower than those commonly employed in the texturization of vegetable proteins that require temperatures of 100-150° C. to achieve their correct texturization.

In various embodiments, the shape and appearance of the spongy starch-free dairy snack of the present invention may vary according to the different dies that are coupled to the extruder outlet, whereby the spongy starch-free dairy snack may have a circular or oval cross-sectional shape, may have a cylindrical or spherical shape, may have an irregular twisted and/or curved shape, may be a combination of pieces, may include voids or holes, may be shaped with a pattern and/or may be flat like a conventional slice. Accordingly, the specific shape of the spongy starch-free dairy snack depends at least on the die and/or extruder used.

Based on the embodiments described above, it is considered that modifications to these described embodiments as well as alternative embodiments will be considered obvious to a person skilled in the art under the present description. It is, therefore, contemplated that the claims encompass such alternative embodiments as are within the scope of the present invention or their equivalents.

1. A method for making a spongy starch-free dairy snack, the method comprising the steps of:
preparing a food paste that includes:
from 75 to 87% by weight of acid casein; and
from 13 to 25% by weight of cheese powder;
extruding the food paste through a die to obtain a string of extruded paste, the extrusion being at a pressure and temperature that enables the powdered cheese particles to fuse with the acid casein particles;
cutting the string of extruded paste into pieces of extruded paste;
allowing the pieces of extruded paste to expand in an environment with ambient pressure and temperature to form pieces of expanded paste; and
drying the pieces of expanded paste to obtain the spongy snack.

2. The method of claim 1, wherein in the step of preparing a food paste, the cheese powder is selected from a group consisting of fresh cheese, semi-mature cheese, mature cheese and combinations thereof.

3. The method of claim 1, wherein in the step of preparing a food paste, the food paste further comprises from 0 to 12% by weight of butterfat or an edible oil selected from a group consisting of canola oil, sunflower oil, safflower oil, safflower oil, olive oil, corn oil, soybean oil, and combinations thereof.

4. The method of claim 1, wherein further comprising the step of hydrating the food paste with alkaline water prior to, or during, the step of extruding the food paste.

5. The method of claim 1, wherein the step of extruding the food paste is performed at a pressure of 45 to 100 bar and at a temperature cycle of 30 to 35° C., 30 to 45° C., 45 to 65° C., 45 to 65° C., 45 to 65° C., 50 to 75° C., 70 to 80° C., 70 to 80° C. and 60 to 90° C.

6. The method of claim 1, wherein the step of drying the pieces of expanded paste ends until the expanded paste reaches a moisture content of 6 to 13% by weight.

7. A method for making a spongy starch-free dairy snack, the method comprising the steps of:
preparing a food paste that includes:
from 75 to 87% by weight of acid casein; and
from 13 to 25% by weight of cheese powder;
extruding the food paste through a die to obtain a string of extruded paste, the extrusion being at a pressure and temperature that enables the powdered cheese particles to fuse with the acid casein particles;
cutting the string of extruded paste into pieces of extruded paste;
allowing the pieces of extruded paste to expand in an environment with ambient pressure and temperature to form pieces of expanded paste; and
drying the pieces of expanded paste to obtain the spongy snack.

8. The method of claim 7, wherein in the step of preparing a food paste, the cheese powder is selected from a group consisting of fresh cheese, semi-mature cheese, mature cheese and combinations thereof.

9. The method of claim 7, wherein in the step of preparing a food paste, the food paste further comprises from 0 to 12% by weight of butterfat or an edible oil selected from a group consisting of canola oil, sunflower oil, safflower oil, safflower oil, olive oil, corn oil, soybean oil, and combinations thereof.

10. The method of claim 7, wherein further comprising the step of hydrating the food paste with alkaline water prior to, or during, the step of extruding the food paste.

11. The method of claim 7, wherein the step of extruding the food paste is performed at a pressure of 45 to 100 bar and at a temperature cycle of 30 to 35° C., 30 to 45° C., 45 to 65° C., 45 to 65° C., 45 to 65° C., 50 to 75° C., 70 to 80° C., 70 to 80° C. and 60 to 90° C.

12. The method of claim 7, wherein the step of drying the pieces of expanded paste ends until the expanded paste reaches a moisture content of 6 to 13% by weight.

13. A spongy starch-free dairy snack amenable to being obtained by the method according to any one of claims 1 to 12, comprising:
a spongy three-dimensional shape with thin-walled alveoli exhibiting fused exfoliated layers of overlapping proteins;
a density of 75 to 150 g/L; and
a protein content of 80% to 89% by weight on a dry basis.
